(19) United States
(12) Patent Application Publication
(10) Pub. No.: US 2005/0281145 A1
(43) Pub. Date: Dec. 22, 2005

(54) Optical pickup and optical disk apparatus

(75) Inventor: Masato Yamagishi, Chiba (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/146,085

(22) Filed: Jun. 7, 2005

(30) Foreign Application Priority Data
Jun. 17, 2004 (JP) 2004-180039

(51) Int. Cl. G11B 7/00; G11B 7/135

(52) U.S. Cl. 369/44.14; 369/44.15; 369/44.22

(57) ABSTRACT

A lensholder has one focus coil and two tracking coil. The lensholder has an accommodation recess portion accommodating an objective lens. A layer having thermal conductivity is provided between an inner peripheral surface of the lensholder and an outer circumferential surface of the objective lens and between a bottom wall of the lensholder and a one-side lens surface. The objective lens is bonded by an adhesive and is thereby mounted in a state where the layer is interposed individually between the inner peripheral surface of the lensholder and the outer circumferential surface of the objective lens and between the bottom wall of the lensholder and the one-side lens surface.

### CROSS REFERENCES TO RELATED APPLICATIONS

The present invention contains subject matter related to Japanese Patent Application JP 2004-180039 filed in the Japanese Patent Office on Jun. 17, 2004, the entire contents of which being incorporated herein by reference.

### BACKGROUND OF THE INVENTION

1. Field of the Invention

The present invention relates to an optical disk apparatus that performing operations such as recording and reproduction of a signal on an optical disk and to an optical pickup for use in the LCD device.

2. Description of the Related Art

Optical pickups perform the operation of recording or reproduction or the operations of recording and reproduction of signals by irradiating optical beams on, for example, a CD (compact disk) and a DVD (digital versatile disk).

An optical pickup of this type includes a lensholder holding an objective lens. The lensholder includes a focus coil provided to move the lensholder in a focus direction, and a tracking coil provided to move the lensholder in a tracking direction.

In recent years, with an enhanced record density of such an optical disk, technical development is in progress to create a shorter wavelength of the light beam and to increase an NA (number of apertures). In addition, plastic lenses are increasingly used as objective lenses for the reasons that forming thereof is easy and the costs therefor can be reduced in comparison to the case of glass lenses.

Plastic lenses are prone to deformation due to temperature variations. When a bias occurs in temperature distribution of the plastic lens, or in other words, when a temperature gradient occurs, a distortion occurs in the lens, whereby various optical aberrations tend to occur.

As such, in the case a plastic lens is used as an objective lens, current flowing to the focus coil and tracking coil causes the coils to produce heats. When the heats transfer to the objective lens through the lensholder, causing optical aberrations attributed to the temperature gradient, there occurs the problem of deterioration in the quality in terms of, for example, servo characteristics and reproduction signals in the optical pickup.

To prevent the problem, an optical pickup has been proposed wherein an annular member formed of a material having high thermal conductivity is interposed between an objective lens and a lensholder, and heats of the lensholder is equalized through the annular member and is thereby transferred to the objective lens, whereby the occurrence of a temperature gradient in the objective lens is restrained (see Japanese Unexamined Patent Application Publication No. 1999-176009, for example).

### SUMMARY OF THE INVENTION

However, in the above-described pickup, since the annular member is provided to the lensholder, the number of components/parts increases, thereby producing disadvantages in implementing a size reduction of the optical pickup and a cost reduction therefor. In addition, since the annular member is interposed between the lensholder and the objective lens, nonuniformity in the precision of the annular member makes it difficult to secure positional precision of the optical axis of the objective lens. This produces the disadvantage of increasing manufacturing costs.

The present invention is made in view of the circumstances described above. Accordingly, the invention is to provide an optical pickup and an optical disk apparatus that allow the implementation of a size reduction and a cost reduction and that are advantageous to prevent occurrence of optical aberrations attributed to a temperature gradient without sacrificing response characteristics.

To achieve the above, according to one embodiment of the invention, an optical pickup includes a lensholder that holds an objective lens; a focus coil that is provided in the lensholder and that serves for movement along a focus direction which is an optical axis of the objective lens of the lensholder; and a tracking coil that is provided in the lensholder and that serves for movement in a tracking direction perpendicular to the focus direction of the lensholder. The objective lens includes an outer circumferential surface with the optical axis of the objective lens in a center, and lens surfaces on two sides of the objective lens in the optical axis direction; the lensholder includes an accommodation recess portion that accommodates the objective lens; the accommodation recess portion includes an inner peripheral surface with a diameter corresponding to the outer circumferential surface of the objective lens, and an annular bottom wall corresponding to a portion close to an outer periphery of a one-side lens surface of the lens surfaces on the two sides; a layer having thermal conductivity is provided between an inner peripheral surface of the lensholder and the outer circumferential surface of the objective lens and between the bottom wall of the lensholder and the one-side lens surface; and the objective lens is mounted in a state where the layer is interposed individually between the inner peripheral surface of the lensholder and the outer circumferential surface of the objective lens and between the bottom wall of the lensholder and the one-side lens surface.

According to another embodiment of the invention, an optical disk apparatus includes driving means that holds and rotationally drives an optical disk; and an optical pickup that irradiates a recording and/or reproduction light beam on the optical disk rotational driven by the driving means and that detects a reflected light beam in accordance with reflected light of the irradiated light beam on the optical disk. The optical pickup includes a lensholder that holds an objective lens; a focus coil that is provided in the lensholder and that serves for movement along a focus direction which is an optical axis of the objective lens of the lensholder; and a tracking coil that is provided in the lensholder and that serves for movement in a tracking direction perpendicular to the focus direction of the lensholder. The objective lens includes an outer circumferential surface with the optical axis of the objective lens in a center, and lens surfaces on two sides of the objective lens in the optical axis direction; the lensholder includes an accommodation recess portion that accommodates the objective lens; the accommodation recess portion includes an inner peripheral surface with a diameter corresponding to the outer circumferential surface of the objective lens, and an annular bottom wall corresponding to a portion close to an outer periphery of a one-side lens surface of the lens surfaces on the two sides; a layer having thermal conductivity is provided between an inner peripheral surface of the lensholder and the outer circumferential surface of the objective lens and between the bottom wall of the lensholder and the one-side lens surface; and the objective lens is mounted in a state where the layer is interposed individually between the inner peripheral surface of the lensholder and the outer circumferential surface of the objective lens and between the bottom wall of the lensholder and the one-side lens surface.

According to the embodiment of the invention, the objective lens is mounted in the accommodation recess portion in the state that the layer having the thermal conductivity is interposed between the inner peripheral surface of the lensholder and the outer circumferential surface of the objective lens and the layer is interposed between the bottom wall of the lensholder and the one-side lens surface.

Accordingly, heat generated by the current flowing to the tracking coil and the focus coil is transferred to the layer 40 through 2 and is transferred to the outer circumferential surface of the objective lens and the one-side lens surface thereof in the state that the heat is diffused by the layer.

Thereby, the heat transferred to the outer circumferential surface of the objective lens and the lens surface thereof through the layer can be distributed to be substantially uniform in the overall areas of the outer circumferential surface and the one-side lens surface 7004.

As such, the temperatures of portions of the objective lens positioned on the circumferences having a same radius with the optical axis of the objective lens in the center each similarly vary outwardly in the radial direction in terms of the temperature gradient across the overall circumference of the objective lens. Accordingly, the temperature gradient in the portions of the objective lens positioned on the circumferences having the same radius in the objective lens 7 can be caused to become substantially zero.

Suppose that the temperature gradient in the objective lens portions positioned on the circumferences having the same radius is substantially zero, as described above. In this case, coma aberrations, astigmatism, and the like as optical aberrations occurring in the objective lens are very low so as to be negligible. Consequently, it is sufficient to take into account only spherical aberrations. Spherical aberrations can be easily corrected for by the optical system of the optical pickup.

Accordingly, different from the past case, the occurrence of the temperature gradient in the objective lens can be restrained without an annular member formed of a material having high thermal conductivity being interposed between the objective lens and the lensholder. Consequently, the number of components/parts can be reduced, thereby making it advantageous to implement a size reduction of the optical pickup and a cost reduction therefor. In addition, since the weight of the layer interposed between the lensholder and the objective lens is negligible, a weight reduction can be implemented for the lensholder, thereby making it advantageous to implement enhancement in the response characteristics of the optical pickup.

Further, the layer interposed between the lensholder and the objective lens is formed integrally with the lensholder, so that, different from the past case where the annular member is interposed between the lensholder and the objective lens, the positional accuracy of the optical axis of the objective lens can easily be secured, thereby making it advantageous to reduce manufacturing costs.

### BRIEF DESCRIPTION OF THE DRAWINGS

The above and other objects, features and advantages of the present invention will become more apparent from the following description of the presently exemplary embodiment of the invention taken in conjunction with the accompanying drawings, in which:

FIG. 1 is a block diagram showing the configuration of an optical disk apparatus including an optical pickup assembled thereinto, according to an embodiment of the present invention;

FIG. 2 is a perspective view showing the optical pickup according to the embodiment of the invention;

FIG. 3 is an exploded perspective view showing a state where a yoke base is removed from the optical pickup; and

FIG. 4 is a schematic view showing a temperature distribution in a state where an objective lens and a lensholder are cut away with a plane perpendicular to an optical axis of the objective lens.

### DETAILED DESCRIPTION OF THE PREFERRED EMBODIMENTS

In the present invention, it is intended that a size reduction and a cost reduction are implemented, and the occurrence of optical aberrations attributed to temperature gradients in an objective lens is prevented without sacrificing response characteristics. This is implemented by providing a layer having thermal conductivity between an inner peripheral surface of a lensholder and an outer peripheral surface of the objective lens and between a bottom wall of the lensholder and a lens surface of the objective lens.

Embodiments of an optical pickup and a recording and reproducing apparatus will be described hereinbelow with reference to the drawings.

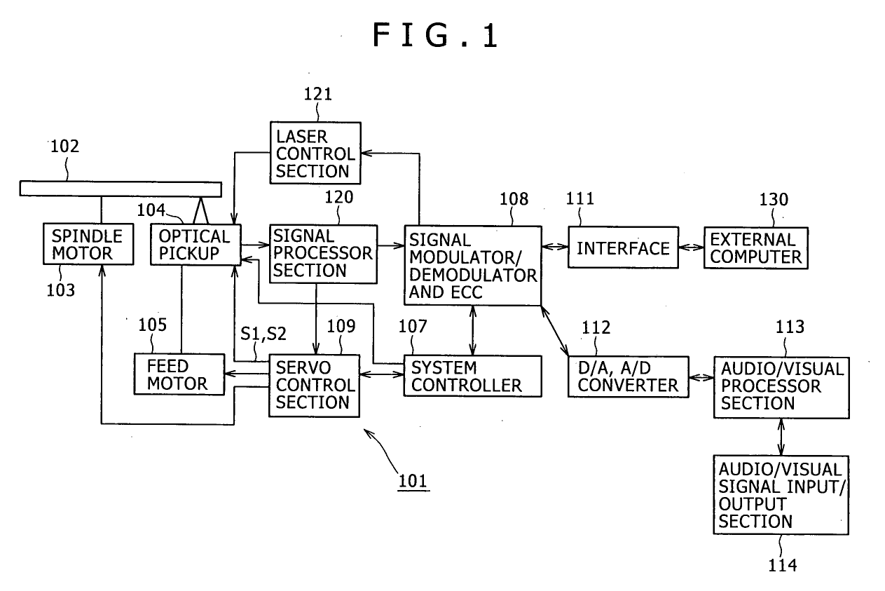

FIG. 1 is a block diagram showing the configuration of an optical disk apparatus including an optical pickup assembled thereinto, according to an embodiment of the present invention.

With reference to FIG. 1, an optical disk apparatus 101 includes a spindle motor 103 serving as driving means that performs rotational driving of an optical disk 102 serving as an optical storage medium, such as a CD-R, DVD±R, DVD-RAM, or Blu-ray; an optical pickup 104; and a feed motor 105 serving as driving means that performs driving of the optical pickup 104 in the radial direction thereof. The spindle motor 103 has a construction that is driven and controlled to provide a predetermined rotation speed by a system controller 107 and a servo control section 109.

A signal modulator/demodulator & ECC block 108 performs modulation, demodulation, and ECC (error correction code) addition on a signal being output from a signal processor section 120. The optical pickup 104 performs irradiation of light beams on a signal recording surface of the optical disk 102 rotating in accordance with instructions issued from the system controller 107 and the servo control section 109. By the light-beam irradiation, recording or reproduction of the light signal is performed on the optical disk 102.

In addition, the optical pickup 104 is configured to perform detection of below-described various types of light beams in accordance with reflected light from the signal recording surface of the optical disk 102 and to supply the signal processor section 120 with signals corresponding to the individual light beams.

The signal processor section 120 is capable of generating servo control signals, namely, a focus error signal, tracking error signal, RF signal, and an ATIP signal necessary to perform rotation control of the optical disk 102 in a recording event, for example, in accordance with detection signals corresponding to respective light beams. In addition, processing such as modulation and error correction processing in accordance with the signals are performed by, for example, the servo control section 109 and the signal modulator/demodulator & ECC block 108 in correspondence to the type of a storage medium being used as a recording object.

In the apparatus configuration, in the event that recording signals demodulated by the signal modulator/demodulator & ECC block 108 are destined for, for example, computer data storage, the signals are transmitted to, for example, an external computer 130 through an interface 111. As such, the external computer 130 or the like is designed to be capable of receiving signals recorded on the optical disk 102 as reproduction signals.

In the event that recording signals demodulated by the signal modulator/demodulator & ECC block 108 are destined for audio/visual purposes, the signal are digital-to-analog converted by a D/A converter of a D/A, A/D converter 112, and the converted signals are supplied to an audio/visual processor section 113. In the audio/visual processor section 113, the signals undergo audio/video signal processing and are transmitted to an external image-capture/display device through an audio/visual signal input/output section 114.

In the apparatus configuration, the optical pickup 104 is connected with the feed motor 105, and is moved by rotation of the feed motor 105 onto a predetermined recording track on the optical disk 102. The servo control section 109 controls the spindle motor 103, controls the feed motor 105, and controls an actuator holding the objective lens of the optical pickup 104 to move in the focusing and tracking directions.

That is, the servo control section 109 controls the spindle motor 103 in accordance with an ATIP signal, and controls the actuator in accordance with a focus error signal and a tracking error signal.

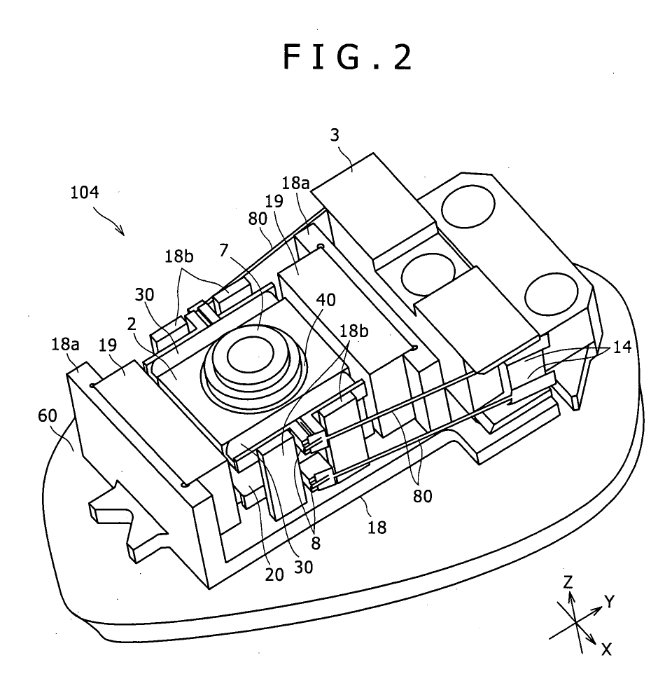

In addition, the servo control section 109 is configured to generate a focusing driving signal S1 for supply to one below-described focus coil 20 (see FIG. 2) and a tracking driving signal S2 (driving current) for supply to two tracking coils 30 (see FIG. 2), in accordance with, for example, a focus error signal, track error signal, and RF signal.

A laser control section 121 controls the laser light source in the optical pickup apparatus 104.

As shown in FIG. 2, a focus direction Z refers to the optical axis direction of an objective lens 7. A tracking direction X refers to the radial direction of the optical disk apparatus 101 perpendicular to the focus direction Z. A tangential direction Y refers to a direction perpendicular to both the focus direction Z and tracking direction X (tangential direction of the circumference of the optical disk apparatus 101).

The optical pickup 104 will be described in more detail herebelow.

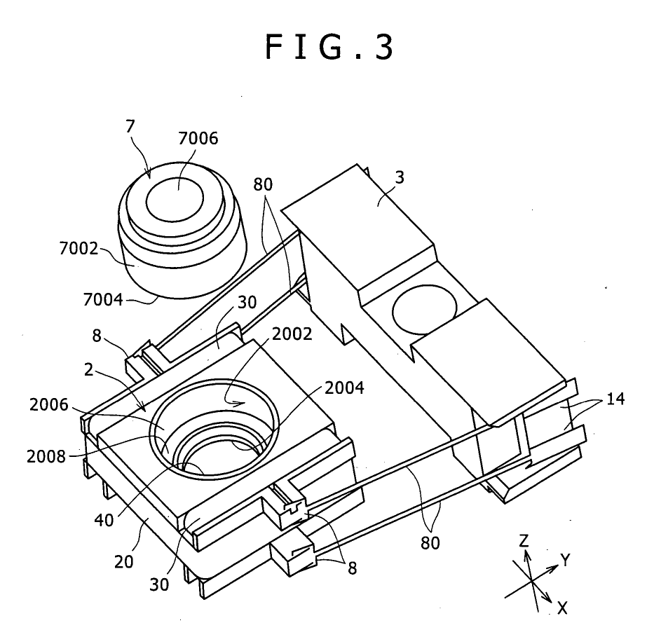

FIG. 2 is a perspective view of the optical pickup 104 according to the first embodiment of the invention, and FIG. 3 is an exploded perspective view showing a state where a yoke base is removed from the optical pickup 104.

The optical pickup 104 includes a semiconductor laser serving as a light source that emanates light; a photodiode serving as a light detector device that detects a reflected light beam from the signal recording surface of the optical disk 102; and an optical system that guides the light from the semiconductor laser to the optical disk 102 and that guides the reflected light beam to the light detector device.

As shown in FIG. 2, the optical pickup 104 is provided on a mount member 60 provided movably in the radial direction of the optical disk 102 in a housing of the optical disk apparatus 101.

The optical pickup 104 includes a lensholder 2, a support block 3, and suspension wires 80. The lensholder 2 holds the objective lens 7 that focuses the light beam emanated from the light source and that irradiates the focused light beam on the optical disk 102. The support block 3 is disposed at spacing in the tangential direction Y from the lensholder 2, and is attached to the mount member 60. The suspension wires 80 connects between the lensholder 2 and the support block 3. The objective lens 7 constitutes a part of the optical system of the optical pickup 104.

As shown in FIG. 2, the support block 3 has a length along the tracking direction X and a height along the focus direction Z.

Two wire support sections 14 are provided at spacings in the focus direction, respectively, on two sides of the support block 3 along the tracking direction X.

In total, four suspension wires 80 are provided. Two wire support sections 8 on each of the two sides in tracking direction X of the support block 3 and two wire support sections 14 on each of the two sides in the tracking direction X of the support block 3 are connected by two suspension wires 80.

The two suspension wires 80 are provided parallel to each other with a spacing therebetween, thereby to support the lensholder 2 movably in the focus and tracking directions Z and X with respect to the support block 3.

The suspension wires 80 are formed of a material having electro-conductivity and resiliency.

In the configuration, an end portion of the respective suspension wires 80 on the side of the support block 3 is connected to the servo control section 109 through a wire member (not shown), whereby the focusing driving signal S1 and the tracking driving signal S2 are supplied thereto from the servo control section 109.

As shown in FIG. 2, a yoke base 18 is mounted to the mount member 60, the support block 3 is mounted to the yoke base 18, the lensholder 2 is disposed over the yoke base 18, and the yoke base 18 has an opening (not shown) in a portion through which the optical axis of the objective lens 7 extends.

A pair of yoke elements 18a opposite each other are provided in elevation on two sides of the yoke base 18 in the tangential direction Y. A monolithic rectangular planar magnet 19 is attached to each of mutually opposing surfaces of the yoke elements 18a in such a manner that the magnet 19 faces each of the two ends of the lensholder 2 in the tangential direction Y and the thickness direction thereof is directed in the tangential direction Y.

In addition, two yoke elements 18b are formed in elevation with a spacing being interposed therebetween in the tangential direction Y. The yoke elements 18b on two sides in the tracking direction X, respectively, face two ends of the lensholder 2 in the tracking direction X.

As shown in FIGS. 2 and 3, a focus coil 20 is wound around an outer circumference of the lensholder 2.

The focus coil 20 has coil faces constituting the focus coil 20 and perpendicular to a coil winding axis, the focus coil 20 is provided so that the coil faces face in the focus direction Z.

Tracking coils 30 are individually attached to two end faces of the lensholder 2 in the tracking direction X. In total, two tracking coils 30 are thus provided.

The respective tracking coil 30 has a coil face constituting the tracking coil 30 and perpendicular to a coil winding axis. The tracking coil 30 is provided so that the coil faces face in the tracking direction X.

The focus coil 20 and the individual tracking coils 30 are electrically connected to end portions of the four suspension wires 80 on the side of the lensholder 2. The focus coil 20 is supplied with the focusing driving signal S1 through the suspension wires 80, and the two tracking coils 30 are supplied with the tracking driving signal S2 through the suspension wires 80.

In the present embodiment, as shown in FIG. 3, the objective lens 7 is configured such that two plastic lenses laminated in the optical axis direction are bonded in an overall shape as a flat circular column. The objective lens 7 has an outer circumferential surface 7002 with optical axis of the objective lens 7 in the center, and lens surfaces 7004 and 7006 positioned on two sides of the objective lens 7 in the optical axis direction.

In the present embodiment, the NA of the objective lens 7 is, for example, 0.805 corresponding to a Blu-ray disk, and the NA corresponds to a 405 nm wavelength light beam.

As shown in FIG. 3, the lensholder 2 is molded of a synthetic resin into an integral unit by using dies, and has such a shape as a rectangular board. The lensholder 2 has, in the center, an accommodation recess portion 2002 for accommodating the objective lens 7, and an opening 2004 in a portion through which the optical axis of the objective lens 7 extends in a bottom portion of the accommodation recess portion 2002.

The accommodation recess portion 2002 includes an inner peripheral surface 2006 corresponding to the outer circumferential surface 7002 of the objective lens 7, and an annular bottom wall 2008 corresponding to a portion close to an outer circumference of a one-side lens surface 7004, which is one of two lens surfaces 7004 and 7006. The annular bottom wall 2008 extends along the outer periphery of the opening 2004.

A layer 40 having thermal conductivity is provided between the inner peripheral surface 2006 of the lensholder 2 and the outer circumferential surface 7002 of the objective lens 7 and between the bottom wall 2008 of the lensholder 2 and the one-side lens surface 7004. In the present embodiment, the layer 40 is provided in a shape rotationally symmetric with respect to the optical axis of the objective lens 7 in the center.

The objective lens 7 is bonded to the accommodation recess portion 2002 by an adhesive in the state that the layer 40 is interposed between the inner peripheral surface 2006 of the lensholder 2 and the outer circumferential surface 7002 of the objective lens 7 and between the bottom wall 2008 of the lensholder 2 and the one-side lens surface 7004.

In the present embodiment, the layer 40 is formed of a metal layer and is provided on the individual accommodation recess portion 2002 and bottom wall 2008 of the lensholder 2. The layer 40 is formed integrally with the lensholder 2 by using an injection-molding circuit parts technique, that is, a MID (molded interconnection device) technique. More specifically, the metal layer is formed by using the dies on surfaces of the accommodation recess portion 2002 and opening 2004 of a molded product of the lensholder 2. The metal layer may be formed not only by the MID, but also by either plating or insert molding.

Operation of the optical pickup 104 will now be described herebelow.

Description will be made with reference to a case where the lensholder 2 is moved along the focus direction Z and the tracking direction X.

When the focusing driving signal S1 is supplied from the servo control section 109 to the focus coil 20, forces in the focus direction Z are generated by magnetic interaction between a magnetic field generated in the focus coil 20 and magnetic fields of the individual magnets 19. Upon exertion of the forces on the lensholder 2, the lensholder 2 is moved along the focus direction Z.

When the tracking driving signal S2 is supplied from the servo control section 109 to the tracking coil 30, forces in the tracking direction X is generated by magnetic interaction between a magnetic field generated in the tracking coil 30 and magnetic fields given from the individual magnets 19. Upon exertion of the forces on the lensholder 2, the lensholder 2 is moved along the tracking direction X.

In a state where the focusing driving signal S1 is not supplied to the focus coil 20, the lensholder 2 is maintained at a neutral position in the focus direction Z in accordance with the resiliency of the suspension wires 80. In a state where the tracking driving signal S2 is not supplied to the tracking coil 30, the lensholder 2 is maintained at a neutral position in the tracking direction X in accordance with the resiliency of the suspension wires 80.

The following will now describe simulation results of temperature distributions in the lensholder 2 and the objective lens 7 in the state where the focusing driving signal S1 has been supplied to the focus coil 20, the tracking driving signal S2 has been supplied to the tracking driving signal S2, and the coils have become exothermic.

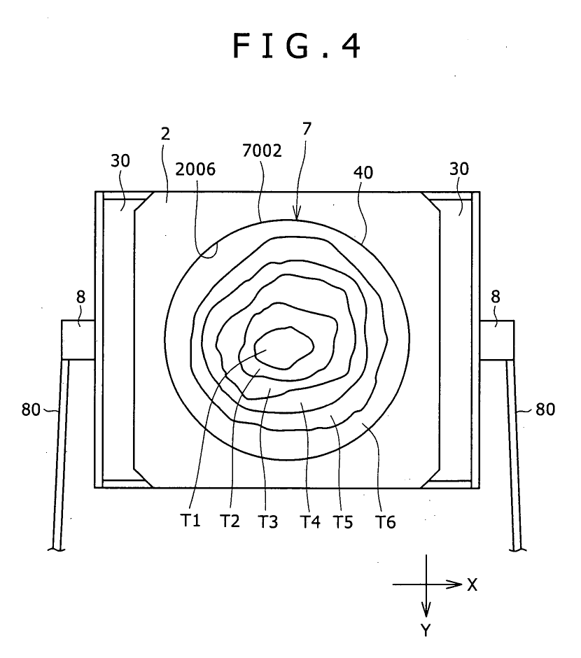

FIG. 4 is a schematic view showing a temperature distribution in a state where the objective lens 7 and the lensholder 2 are cut away with a plane perpendicular to the optical axis of the objective lens 7.

In the state where the focusing driving signal S1 has been supplied to the focus coil 20, the tracking driving signal S2 has been supplied to the tracking driving signal S2, and the coils have become exothermic, the temperature on the two end sides of the lensholder 2 in the tracking direction X rise to be higher in comparison to the temperatures in the two end portions of the lensholder 2 in the tangential direction Y. Thereby, a bias occurs in the temperature distribution in the lensholder 2.

In the present embodiment, as shown in FIGS. 2 to 4, the objective lens 7 is mounted in the accommodation recess portion 2002 in the state that the thermally-conductive layer 40 is interposed between the inner peripheral surface 2006 of the lensholder 2 and the outer circumferential surface 7002 of the objective lens 7 and the layer 40 is interposed between the bottom wall 2008 of the lensholder 2 and the one-side lens surface 7004 of the objective lens 7.

Accordingly, heat generated by the current flowing to the focus coil 20 and the two tracking coils 30 is transferred to the layer 40 through 2 and is transferred to the outer circumferential surface 7002 of the objective lens 7 and the one-side lens surface 7004 thereof in the state that the heat is diffused by the layer 40.

Thereby, the heat transferred to the outer circumferential surface 7002 of the objective lens 7 and the one-side lens surface 7004 thereof through the layer 40 can be distributed to be substantially uniform in the overall areas of the outer circumferential surface 7002 and the one-side lens surface 7004.

In FIG. 4, characters T1 to T6 denote the temperatures, wherein the relations between the individual temperatures are T1<T2<T3<T4<T5<T6, and the temperature differences between the adjacent temperatures in the T1, T2, T3, T4, T5, and T6 are constant. In the event of the simulation, the environmental temperature of the optical pickup 104 is set, and the temperature distribution in the yoke base 18 of the optical pickup 104 is analyzed. However, such detailed information is omitted from description given below.

As such, clearly from FIG. 4, the temperatures T1 to T6 of the objective lens 7 portions positioned on the circumferences having the same radius with the optical axis of the objective lens 7 in the center each similarly vary outwardly in the radial direction in terms of the temperature gradient across the overall circumference of the objective lens 7. Accordingly, the temperature gradient in the objective lens 7 portions positioned on the circumferences having the same radius in the objective lens 7 can be caused to become substantially zero.

Suppose that the temperature gradient in the objective lens 7 portions positioned on the circumferences having the same radius in the objective lens 7 is substantially zero, as described above. In this case, coma aberrations, astigmatism, and the like as optical aberrations occurring in the objective lens 7 are very low so to be negligible. Consequently, it is sufficient to take into account only spherical aberrations. Spherical aberrations can be easily corrected for by the optical system of the optical pickup 104.

According to the present embodiment, different from the past case, the occurrence of the temperature gradient in the objective lens 7 can be restrained without an annular member formed of a material having high thermal conductivity being interposed between the objective lens 7 and the lensholder 2. Consequently, the number of components/parts can be reduced, thereby making it advantageous to implement size reduction of the optical pickup 104 and cost reduction therefor. In addition, since the weight of the layer 40 interposed between the lensholder 2 and the objective lens 7 is negligible, a weight reduction can be implemented for the lensholder 2, thereby making it advantageous to implement enhancement in the response characteristics of the optical pickup 104.

In addition, the layer 40 interposed between the lensholder 2 and the objective lens 7 is formed integrally with the lensholder 2, so that, different from the past case where the annular member is interposed between the lensholder and the objective lens, the positional accuracy of the optical axis of the objective lens 7 can easily be secured, thereby making it advantageous to reduce manufacturing costs.

The present embodiment has been described by reference to the case that the layer 40 is provided to the lensholder 2. However, the layer 40 may of course be provided on the outer circumferential surface 7002 of objective lens 7 and a portion close to the outer circumference of the one-side lens surface 7004 thereof.

In addition, the present embodiment has been described by reference to the case that the layer 40 is provided in the shape rotationally symmetric with respect to the optical axis of the objective lens 7 in the center. However, of course, the shape of the layer 40 may be such that, in accordance with the simulation results, the temperature gradient in the objective lens 7 portions positioned on the circumferences having the same radius of the objective lens 7 becomes substantially zero.

Further, although the present embodiment has been described with reference to the case that the objective lens 7 is configured on the plastic lenses, the invention may of course be applied to a case where the objective lens 7 is configured of glass lenses.

Further, the present embodiment has been described by reference to the case that the NA of the objective lens 7 is 0.85. However, the invention is particularly suited for use with an optical pickup that is required to ultimately prevent the occurrence of astigmatism, coma aberrations, and the like and hence uses an objective lens with an NA of 0.8 or higher.

However, the invention may of course be applied to an optical pickup containing an objective lens with an NA of lower than 0.8.

Furthermore, in the present embodiment, only the focus coil and tracking coils are mounted in the lensholder holding the objective lens. However, the invention may of course be applied to a configuration wherein a coil for performing driving in a direction other than the described directions, such as a tilting coil is mounted.

While the present invention has been described as above, it is to be understood that other changes and variations may be made without departing from the spirit or scope of the appended claims.

1. An optical pickup comprising:
a lensholder that holds an objective lens;
a focus coil that is provided in the lensholder and that serves for movement along a focus direction which is an optical axis of the objective lens of the lensholder; and
a tracking coil that is provided in the lensholder and that serves for movement in a tracking direction perpendicular to the focus direction of the lensholder,
wherein
the objective lens includes an outer circumferential surface with the optical axis of the objective lens in a center, and lens surfaces on two sides of the objective lens in the optical axis direction;
the lensholder includes an accommodation recess portion that accommodates the objective lens;
the accommodation recess portion includes an inner peripheral surface with a diameter corresponding to the outer circumferential surface of the objective lens, and an annular bottom wall corresponding to a portion close to an outer periphery of a one-side lens surface of the lens surfaces on the two sides;
a layer having thermal conductivity is provided between an inner peripheral surface of the lensholder and the outer circumferential surface of the objective lens and between the bottom wall of the lensholder and the one-side lens surface; and
the objective lens is mounted in a state where the layer is interposed individually between the inner peripheral surface of the lensholder and the outer circumferential surface of the objective lens and between the bottom wall of the lensholder and the one-side lens surface.

2. An optical pickup according to claim 1, wherein the layer is provided individually on the inner peripheral surface of the lensholder and the bottom wall thereof.

3. An optical pickup according to claim 1, wherein the layer is provided individually on the outer circumferential surface of the objective lens and the one-side lens surface thereof.

4. An optical pickup according to claim 1, wherein the layer is a metal layer, and the layer is formed integrally with any one of the lensholder and the objective lens by using an injection-molding circuit parts technique, namely, a MID (molded interconnection device) technique.

5. An optical pickup according to claim 1, wherein:
a support block is provided with a spacing from the lensholder in a tangential direction which is a direction perpendicular to both the focus direction and the tracking direction; and
the lensholder is supported by the support block to be movable along the focus direction and the tracking direction through a plurality of suspension wires.

6. An optical pickup according to claim 1, wherein the objective lens is configured of a plastic lens.

7. An optical pickup according to claim 1, wherein a number of apertures of the objective lens is 0.8 or higher.

8. An optical disk apparatus comprising:
driving means that holds and rotationally drives an optical disk; and
an optical pickup that irradiates a recording and/or reproduction light beam on the optical disk rotational driven by the driving means and that detects a reflected light beam in accordance with reflected light of the irradiated light beam on the optical disk, the optical pickup including
a lensholder that holds an objective lens;
a focus coil that is provided in the lensholder and that serves for movement along a focus direction which is an optical axis of the objective lens of the lensholder; and
a tracking coil that is provided in the lensholder and that serves for movement in a tracking direction perpendicular to the focus direction of the lensholder,
wherein
the objective lens includes an outer circumferential surface with the optical axis of the objective lens in a center, and lens surfaces on two sides of the objective lens in the optical axis direction;
the lensholder includes an accommodation recess portion that accommodates the objective lens;
the accommodation recess portion includes an inner peripheral surface with a diameter corresponding to the outer circumferential surface of the objective lens, and an annular bottom wall corresponding to a portion close to an outer periphery of a one-side lens surface of the lens surfaces on the two sides;
a layer having thermal conductivity is provided between an inner peripheral surface of the lensholder and the outer circumferential surface of the objective lens and between the bottom wall of the lensholder and the one-side lens surface; and
the objective lens is mounted in a state where the layer is interposed individually between the inner peripheral surface of the lensholder and the outer circumferential surface of the objective lens and between the bottom wall of the lensholder and the one-side lens surface.

9. An optical disk apparatus according to claim 8, wherein the layer is provided individually on the inner peripheral surface of the lensholder and the bottom wall thereof.

10. An optical disk apparatus according to claim 8, wherein the layer is provided individually on the outer circumferential surface of the objective lens and the one-side lens surface thereof.

11. An optical disk apparatus according to claim 8, wherein the layer is a metal layer, and the layer is formed integrally with any one of the lensholder and the objective lens by using an injection-molding circuit parts technique, namely, a MID (molded interconnection device) technique.

12. An optical disk apparatus according to claim 8, wherein:
a support block is provided with a spacing from the lensholder in a tangential direction which is a direction perpendicular to both the focus direction and the tracking direction; and
the lensholder is supported by the support block to be movable along the focus direction and the tracking direction through a plurality of suspension wires.

13. An optical disk apparatus according to claim 8, wherein the objective lens is configured of a plastic lens.

14. An optical disk apparatus according to claim 8, wherein a number of apertures of the objective lens is 0.8 or higher.
